(19) United States
(12) Patent Application Publication
(10) Pub. No.: US 2008/0253847 A1
(43) Pub. Date: Oct. 16, 2008

(54) Adjustable Machine Tool Cutting Insert Holder Apparatus

(75) Inventor: Roger Nicholas, Akron, OH (US)

Correspondence Address: KENNAMETAL INC.;Intellectual Property Department, P.O. BOX 231, 1600 TECHNOLOGY WAY, LATROBE, PA, 15650, US

(73) Assignee: MANCHESTER TOOL COMPANY, Akron, OH (US)

(21) Appl. No.: 11/660,423

(22) PCT Filed: Aug. 12, 2005
(86) PCT No.: PCT/US05/28938

§ 371 Date: Jun. 11, 2008

Related U.S. Application Data
(60) Provisional application No. 60/602,915, filed on Aug. 19, 2004.

(51) Int. Cl. B23G 5/18; B23P 11/00

(52) U.S. Cl. 407/101; 29/525.11

(57) ABSTRACT

An adjustable threading tool assembly. A cutting insert holder is adjustably held in a pocket in a toolholder. The cutting angle of the insert can be set by selecting a precision ground washer that sets the position of a retaining bolt that holds the insert in the pocket such that the desired angle is provided.

### BACKGROUND

Metal machining can be accomplished by mounting a workpiece on a rotating chuck of a lathe, and moving the cutting edge of an insert into the workpiece to thread, groove, or otherwise remove metal from the workpiece. The insert is usually mounted on a holder apparatus that is, in turn, mounted on a tool post and adjustable slide of a carriage of the lathe. U.S. Pat. No. 5,308,197 to Little, which is assigned to the assignee of the present application and incorporated herein by reference in its entirety, describes a cutting insert that has multiple cutting edges mounted on a holder apparatus. When one of the cutting edges wears out, the insert is rotated so that a fresh cutting edge is provided.

The performance of a thread cutting carbide insert can be enhanced by positioning the insert at an angle that is normal to the helix angle of the thread being cut. Positioning the insert cutting edge normal to the thread helix insures that the clearance angles on the sides of the insert are balanced and equal, resulting in even wearing of the flank faces and improved tool life. Secondarily, by locating the insert normal to the helix, chip flow is improved, so that the chip is directed away from the workpiece in an orderly fashion, resulting in improved finishes and avoiding potential insert failures due to chip recutting.

A multitude of helix angles exist for the varieties of thread pitches that are manufactured. To accommodate the numbers of helix angles, toolholders can be custom made each with a unique angle against which to place the cutting insert so that the insert is positioned with its cutting edge normal to a specific helix angle. This approach incurs significant cost and inventory. One alternative to stocking multiple toolholders is using a single toolholder on which a variety of shims are placed under the insert. The various shims have top surfaces that are ground to the different angles that are typically needed for proper helix angle positioning. The shims are installed between the cutting insert and the toolholder to set the angle at which the cutting insert confronts the thread helix. While this approach reduces the number of toolholders that must be in inventory, it requires that a significant quantity of shims must be stocked to match the many thread pitches that are manufactured. In addition, because the shim is adjacent to the cutting insert, the shims are frequently damaged by cutting insert failures and must then be scrapped. In addition, with respect to the multiple cutting edge insert described above, the shim must be repositioned each time the cutting edge is rotated.

### SUMMARY

A toolholder is provided that incorporates a cutting edge angle adjustment member that does not contact the cutting insert. The cutting insert is held in an insert holder that has an adjustment face that confronts a receiving surface in the toolholder. The receiving surface and adjustment face engage one another in multiple positions, each of which sets a unique cutting edge angle relative to a workpiece that is acted on by the cutting edge. The adjustment face is drawn into fixed position with the receiving surface by a connecting device, such as a bolt, that engages an adjustment member, such as a washer, in the toolholder. The adjustment member sets the position of the connecting device relative to the adjustment face. This causes the adjustment face to confront the receiving surface at a predetermined relative position and thereby fix the cutting edge at a desired angle.

A cutting insert that cuts a workpiece includes a cutting insert holder that supports the cutting insert. A toolholder that is adapted to be connected at a distal end to a workpiece cutting machine includes an insert holder receiver that adjustably supports the cutting insert holder. A cutting angle adjustment member coacts with the insert holder receiver to set the position of the cutting insert holder in the cutting insert holder receiver. Thereby, the insert assembly holds the cutting insert in a cutting position in which a cutting edge of the cutting insert confronts a surface of the workpiece at a cutting insert angle dependant on the position of the insert holder in the insert holder receiver.

The cutting insert holder can advantageously include a first arcuate surface, the insert holder receiver having a corresponding second arcuate surface that confronts the first arcuate surface to provide even contact between the cutting insert holder and the insert holder receiver. The first arcuate surface includes a raised track and the second arcuate surface includes a groove configured to slidably engage the raised track such that when the raised track is inserted in the groove the axial position of the cutting insert holder is fixed with respect to the toolholder while the radial position of the cutting insert holder can be adjusted.

In one embodiment, the first surface features a threaded hole and the insert assembly includes a bolt that protrudes through a slot in the insert holder receiver to connect the cutting insert holder to the insert holder receiver. In this case, the cutting angle adjustment member is a washer through which the bolt is inserted and the washer has an alignment feature, such as a precision ground angled top surface upon which an underside of the bolt head rests, that determines an orientation of the cutting insert holder within the insert holder receiver.

The insert holder receiver can advantageously include a washer engaging recess while the washer includes a bottom surface having a corresponding shape to washer engaging recess.

The washer engaging recess can be is a pocket that closely fits around an outer periphery of the washer or a slot along which the washer can be moved. The washer can be oriented in two opposite orientations within the slot, a first orientation that results in a first cutting insert angle and a second orientation that results in a second cutting angle. According to an additional feature the cutting insert holder and the insert holder receiver include alignment indicia that indicate the cutting insert angle that results from the present cutting insert holder position within the insert holder receiver.

Additional features and advantages will become apparent from the following description of an illustrated embodiment made with reference to the accompanying drawings which form part of the specification.

### BRIEF DESCRIPTION OF THE DRAWINGS

FIG. 1 is an exploded view of cutting tool assembly constructed in accordance with an embodiment of the present invention;

FIG. 2 is an exploded view of cutting tool assembly constructed in accordance with an embodiment of the present invention;

FIGS. 3 and 4 are front views of the cutting tool assembly with a cutting edge angle of positive 3 degrees and negative 3 degrees, respectively;

FIGS. 5 and 6 are cross sectional views of the cutting tool assembly adjusted as shown in FIGS. 3 and 4, respectively;

FIGS. 7-9 are perspective views of alternative angle adjustment washers that are configured according to an embodiment of the present invention; and

FIGS. 10-12 are perspective views of cutting tool assemblies having a variety of cutting inserts, the tool assemblies being constructed in accordance with an embodiment of the present invention.

### DETAILED DESCRIPTION

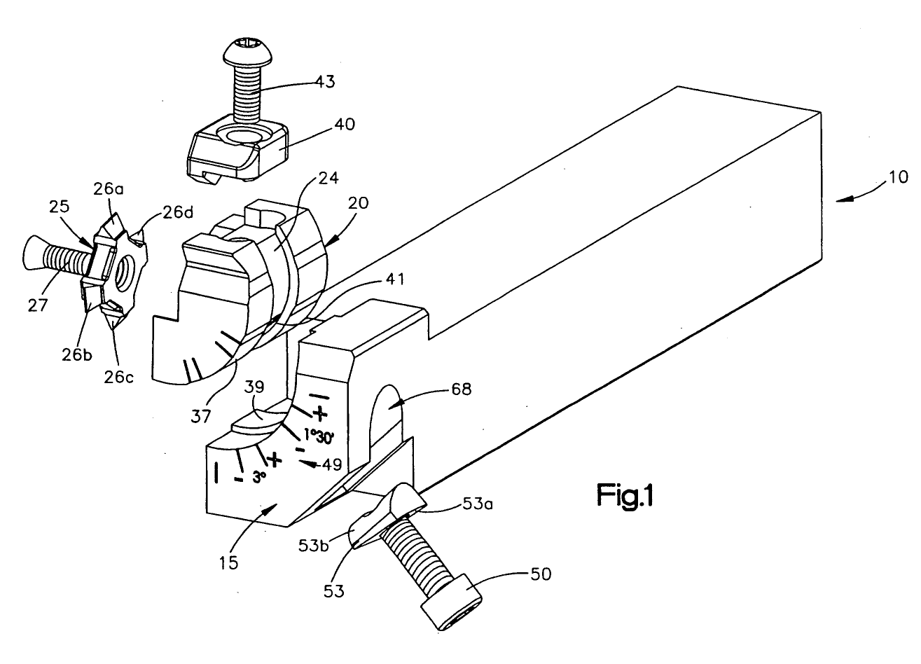

Referring to FIG. 1, a machine tool holder assembly 10 that houses a cutting insert 25 with four cutting edges 26a-26d is shown. The cutting insert 25 is mounted in an insert holder 20 by a screw 27 and a clamp 40 that is screwed into the insert holder with a screw 43. Details about the cutting insert 25 and the manner in which it is connected to the insert holder 24 can be found in U.S. Pat. No. 5,308,197, referenced above.

The tool holder assembly 10 includes an insert receiving end 15 with a curved arcuate surface 17 configured to mate with an outside curved surface 37 of the insert holder 24. The curved arcuate surface has a raised track 39 that engages a mating groove 24 on the insert holder. The mating groove 24 provides a close fit with the track 39 to locate the insert holder along the axis of the tool holder 10 while allowing the insert holder 20 to rotate along the track within the receiving surface 17.

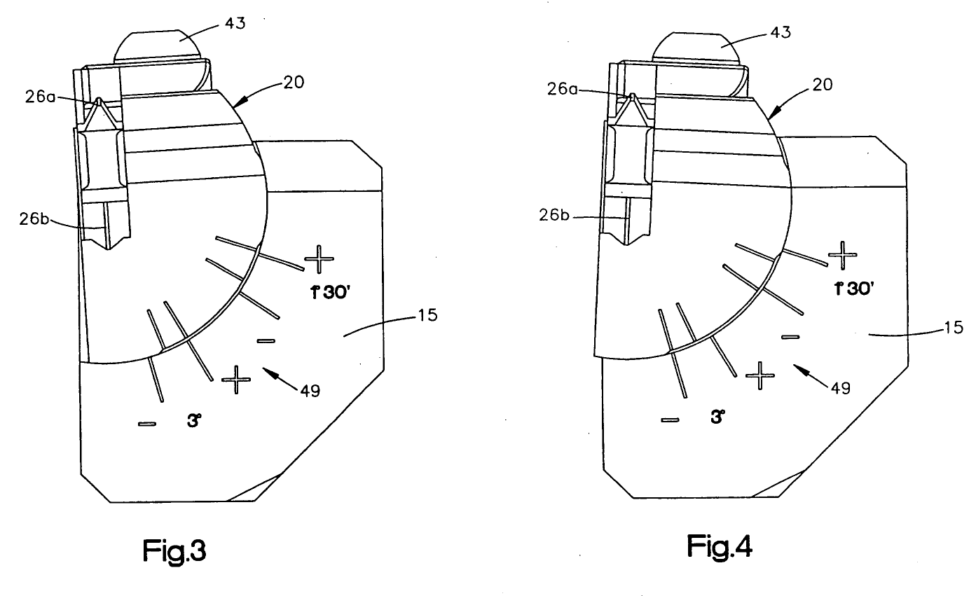

As discussed in the Background, it is often advantageous to set the angle at which the cutting edge 26b confronts the workpiece (not shown). Rotation of the insert holder 20 along the track 39 accomplishes this angle adjustment. Accordingly, the need for shimming the cutting insert or providing an array of insert holders, each providing a specified cutting angle, as practiced in the prior art, is eliminated. FIGS. 3 and 4 illustrate the position of the insert holder 20 in the receiving end 15 at a positive three degree cutting angle and a negative three degree cutting angle, respectively. As is evident from FIGS. 3 and 4, a desired one of a set of angle adjustment indicia 49 that are imprinted on the receiving end 15 is aligned with a desired one of a set of cutting angle adjustment lines 56 that are imprinted on the insert holder 20 to achieve a desired angle setting.

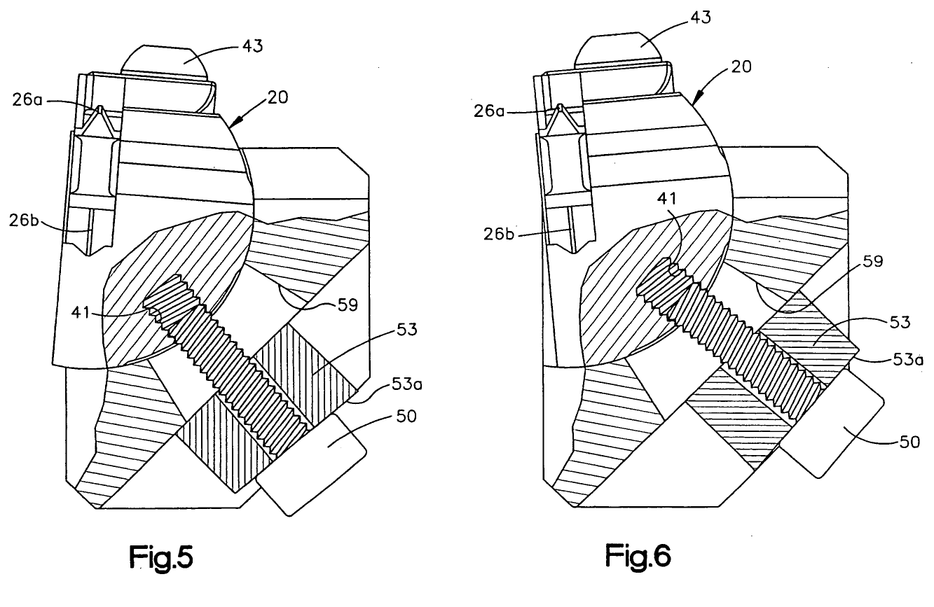

Referring to FIGS. 5 and 6, the insert holder 20 is fixed in place with an adjustment bolt 50 having a head that rests on a precision ground adjustment washer 53 when the bolt is threaded into the insert holder 20. The adjustment bolt 50 protrudes through a slot 59 (see FIGS. 5 and 6) to thread into a threaded hole 41 in the insert holder 41. The width of the slot 59 defines the range of cutting edge angles that can be achieved. The precision ground washer 53 has an angled face 53a upon which the bolt 50 rests along the full underside of its head when properly assembled. The angle on the precision ground washer face 53a therefore determines the rotational position within the slot 59 at which the bolt 50 engages the threaded hole 41 in the insert holder 20, thus fixing the rotational position of the insert holder.

The angle of the top surface of the precision ground washer 53a is selected to provide a given cutting edge angle. Rotation of the precision ground washer 180 degrees provides an equal angle adjustment of the opposite polarity. Accordingly, the same washer 53 provides a cutting edge angle of positive three degrees when oriented as shown in FIG. 5 and a cutting edge angle of negative three degrees when oriented as shown in FIG. 6. An additional precision ground washer is provided to obtain the positive and negative one degree 30 minute cutting edge angles. The washers are labeled with the cutting edge angle they provide, and because a single washer provides a positive and negative cutting angle, the number of washers required is reduced by half. Referring to FIG. 1, the adjustment washer 53 features a curved surface 53b that can slide within a curved slot 68 in the receiving end 15. In this manner, the adjustment washer can be moved within the slot to the position at which the bolt head rests flatly on the washer's angled surface 53a to ensure proper adjustment regardless of the orientation of the washer.

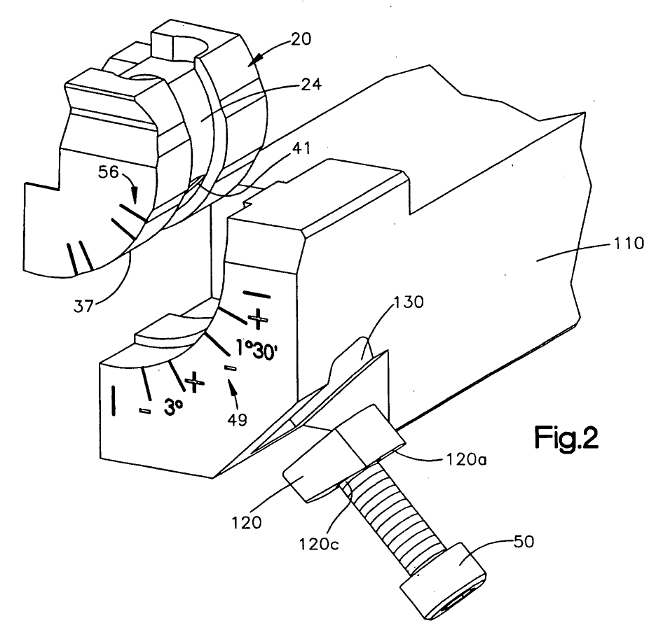

Referring to FIG. 2, an alternative embodiment is shown. In this embodiment, a precision ground washer 120 is fit within a pocket 130 (rather than a slot) in a modified receiving end 110. The precision washer 120 has an angled face 120a upon which the underside of the adjustment bolt 50 rests flatly when the bolt 50 engages the hole 41 at the proper location to provide the desired angle. In addition to the angled face 120a, the washer has a slotted bore 120c that allows the adjustment bolt 50 to be properly positioned to engage the threaded hole to provide the desired angle. In this embodiment, because there is no slot in the receiving end 10 for the washer to slide along, a different washer is necessary for each cutting edge angle.

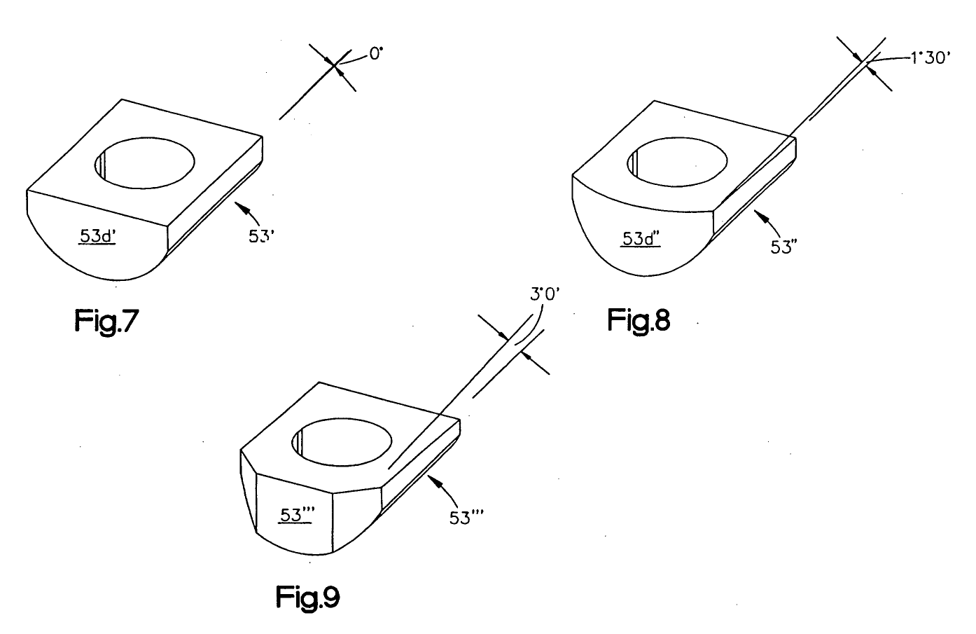

FIGS. 7-9 illustrate adjustment washers 53′,53″,53′″ that have an identifying front edge 53d′,53d″,53d′″. The flat front edge 53d′ in FIG. 7 indicates that the washer provides a 0 degree cutting edge angle. The curved front edge 53d″ in FIG. 8 indicates that the washer provides a 1 degree 30 minute, positive or negative depending on the orientation, cutting edge angle. The angled front edge 53d′″ in FIG. 9 indicates that the washer provides a 3 degree, positive or negative, cutting edge angle. This identifying front edge makes it easier to distinguish the washers from one another, especially when they are coated with oil or debris.

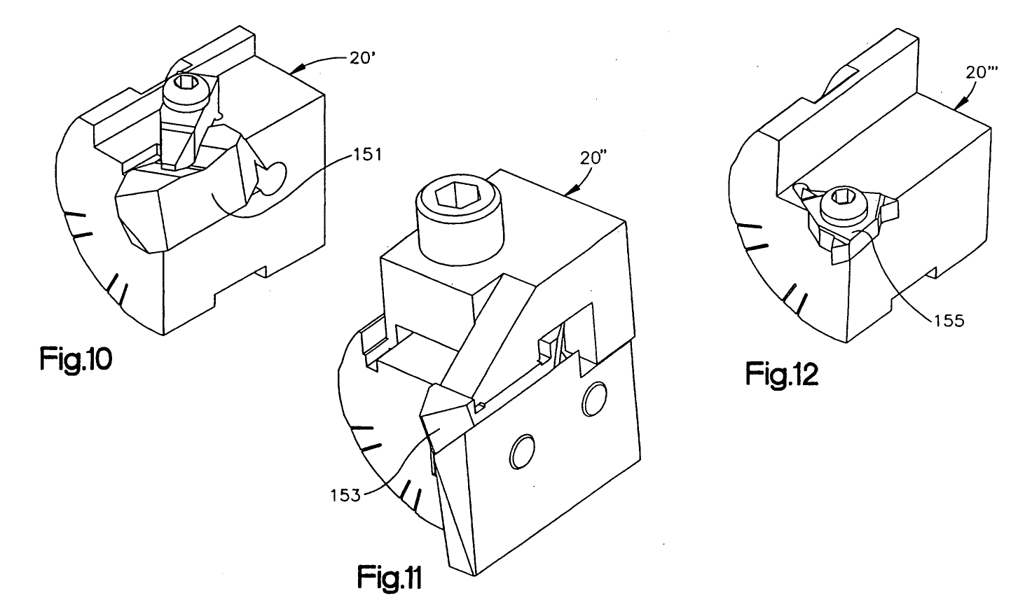

While a four cutting edge insert 25 has been described herein, a variety of cutting insert types can mounted in an insert holder constructed according to the present invention. FIG. 10 illustrates a notched top type insert 151 mounted in an insert holder 20′ that is adapted to hold this type of insert. FIG. 11 illustrates a dogbone type insert 153 mounted in an insert holder 20″ that is adapted to hold this type of insert. FIG. 12 illustrates a lay down triangle type insert 155 mounted in an insert holder 20′″ that is adapted to hold this type of insert.

While the invention has been illustrated and described in considerable detail the invention is not to be considered limited to the precise constructions disclosed. Various adaptations, modifications and uses of the invention may occur to those skilled in the art to which the invention relates. The intention is to cover hereby all such adaptations, modifications and uses that fall within the spirit or scope of the appended claims.

I claim

1. An insert assembly comprising:
a cutting insert that cuts a workpiece;
a cutting insert holder that supports the cutting insert;
a toolholder adapted to be connected at a distal end to a workpiece cutting machine and including an insert holder receiver that adjustably supports the cutting insert holder;
a cutting angle adjustment member that coacts with the insert holder receiver to set the position of the cutting insert holder in the cutting insert holder receiver; and
wherein the insert assembly holds the cutting insert in a cutting position in which a cutting edge of the cutting insert confronts a surface of the workpiece at a cutting insert angle dependant on the position of the insert holder in the insert holder receiver.

2. The insert assembly of claim 1 wherein the cutting insert holder includes a first arcuate surface and the insert holder receiver has a corresponding second arcuate surface that confronts the first arcuate surface to provide even contact between the cutting insert holder and the insert holder receiver.

3. The insert assembly of claim 2 wherein the first arcuate surface includes a raised track and the second arcuate surface includes a groove configured to slidably engage the raised track and wherein when the raised track is inserted in the groove the axial position of the cutting insert holder is fixed with respect to the toolholder while the radial position of the cutting insert holder can be adjusted.

4. The insert assembly of claim 2 including a threaded hole in the first arcuate surface, the insert assembly further including a bolt that protrudes through a slot in the insert holder receiver to connect the cutting insert holder to the insert holder receiver and wherein the cutting angle adjustment member is a washer through which the bolt is inserted, the washer having an alignment feature that determines an orientation of the cutting insert holder within the insert holder receiver.

5. The insert assembly of claim 4 wherein the alignment feature is a precision ground angled top surface upon which an underside of the bolt head rests.

6. The insert assembly of claim 4 wherein the insert holder receiver includes a washer engaging recess and wherein the washer includes a bottom surface having a corresponding shape to washer engaging recess.

7. The insert assembly of claim 6 wherein the washer engaging recess is a pocket that closely fits around an outer periphery of the washer.

8. The insert assembly of claim 6 wherein the washer engaging recess is a slot along which the washer can be moved.

9. The insert assembly of claim 8 wherein the washer can be oriented in two opposite orientations within the slot, a first orientation that results in a first cutting insert angle and a second orientation that results in a second cutting angle.

10. The insert assembly of claim 1 wherein the cutting insert holder and the insert holder receiver include alignment indicia that indicate the cutting insert angle that results from the present cutting insert holder position within the insert holder receiver.

11. An insert assembly comprising:
a cutting insert that cuts a workpiece;
a cutting insert holder that supports the cutting insert and includes a first arcuate surface with a raised track thereon and a threaded hole therein;
a toolholder adapted to be connected at a distal end to a workpiece cutting machine and including an insert holder receiver that has second arcuate surface that includes a groove configured to slidably engage the raised track to adjustably support the cutting insert holder such that when the raised track is inserted in the groove the axial position of the cutting insert holder is fixed with respect to the toolholder while the radial position of the cutting insert holder can be adjusted;
a bolt that protrudes through a slot in the insert holder receiver to connect the cutting insert holder to the insert holder receiver and a washer through which the bolt is inserted, the washer having an alignment feature that determines an orientation of the cutting insert holder within the insert holder receiver; and
wherein the insert assembly holds the cutting insert in a cutting position in which a cutting edge of the cutting insert confronts a surface of the workpiece at a cutting insert angle dependant on the position of the insert holder in the insert holder receiver.

12. The insert assembly of claim 1 1 wherein the alignment feature is a precision ground angled top surface upon which an underside of the bolt head rests.

13. The insert assembly of claim 11 wherein the insert holder receiver includes a washer engaging recess and wherein the washer includes a bottom surface having a corresponding shape to washer engaging recess.

14. The insert assembly of claim 13 wherein the washer engaging recess is a pocket that closely fits around an outer periphery of the washer.

15. The insert assembly of claim 13 wherein the washer engaging recess is a slot along which the washer can be moved.

16. The insert assembly of claim 15 wherein the washer can be oriented in two opposite orientations within the slot, a first orientation that results in a first cutting insert angle and a second orientation that results in a second cutting angle.

17. The insert assembly of claim 11 wherein the cutting insert holder and the insert holder receiver include alignment indicia that indicate the cutting insert angle that results from the present cutting insert holder position within the insert holder receiver.

18. A method that fixes a cutting insert angle with respect to a workpiece comprising:
mounting a cutting insert in an insert holder having a first arcuate surface that includes a threaded hole:
placing the insert holder in a receiver on a toolholder, the receiver including a second arcuate surface that confronts the first arcuate surface and a slot through which a bolt is inserted to be threaded into the threaded hole;
placing an alignment washer in an alignment washer recess in the receiver, the alignment washer having an alignment feature that determines the relative position of the insert holder with respect to the receiver when the bolt is threaded into the threaded hole;
inserting the bolt through the alignment washer within the recess and the slot; and
threading the bolt into the threaded hole thereby fixing the insert holder in the receiver at the predetermined relative position.

19. The method of claim 18 wherein the alignment washer is placed within the alignment washer recess by sliding the alignment washer along a slot in the receiver until an underside of the bolt head rests flush on a precision ground top surface of the washer.
